(19) United States
(12) Patent Application Publication
(10) Pub. No.: US 2004/0046510 A1
(43) Pub. Date: Mar. 11, 2004

(54) Direct AC driven LED light string

(75) Inventor: Mark R. Allen, Encinitas, CA (US)

Correspondence Address: LINIAK BERENATO & WHITE, SUITE 240, 6550 ROCK SPRING DRIVE, BETHESDA, MD, 20817, US

(73) Assignee: FIBER OPTIC DESIGNS, INC

(21) Appl. No.: 10/657,256

(22) Filed: Sep. 9, 2003

Related U.S. Application Data
(63) Continuation of application No. 09/339,616, filed on Jun. 24, 1999.
Application No. 09/339,616 is a continuation-in-part of application No. 09/141,914, filed on Aug. 28, 1998, now Pat. No. 6,072,280.
(60) Provisional application No. 60/119,804, filed on Feb. 12, 1999.

(51) Int. Cl. H05B 37/00

(52) U.S. Cl. 315/185 S; 315/185 R

(57) ABSTRACT

An LED light string employs a plurality of LEDs wired in block series-parallel, where the one or more series blocks, each driven at the same input voltage as the source voltage (110 VAC or 220 VAC), are coupled in parallel. The LED light string interfaces to the source voltage using a common household plug; it may also include a corresponding common, household socket, coupled in electrical parallel, to enable multiple light strings to be connected to each other from end to end. LEDs of the light string may comprise either a single color LED or an LED including multiple sub-dies each of a different color. The LED lenses may be of any shape, and may be clear, clear-colored, or diffuse-colored. Moreover, each LED may have internal circuitry to provide for intermittent on-off blinking and/or intermittent LED sub-die color changes.

### CROSS REFERENCES TO RELATED APPLICATIONS

This application is a Continuation of copending application Ser. No. 09/339,616, filed Jun. 24, 1999, which is a continuation-in-part of copending application Ser. No. 09/141,914 filed Aug. 28, 1998; the entire disclosures of which are incorporated herein by reference. This application claims benefit of U.S. Provisional Application No. 60/119,804 filed Feb. 12, 1999.

### BACKGROUND OF THE INVENTION

1. Field of Invention

The present invention relates to light strings and, more particularly, to decorative and stable light strings employing LEDs driven directly by an alternating current power source.

2. Description of Related Art

Light emitting diodes (LEDs) are increasingly employed as a basic lighting source in a variety of forms, including decorative lighting, for reasons among the following. First, as a device, LEDs have a very long lifespan, compared with common incandescent and fluorescent sources, with typical LED lifespan at least 100,000 hours. Second, LEDs have several favorable physical properties, including ruggedness, cool operation, and ability to operate under wide temperature variations. Third, LEDs are currently available in all primary and several secondary colors, as well as in a “white” form employing a blue source and phosphors. Fourth, with newer doping techniques, LEDs are becoming increasingly efficient, and colored LED sources currently available may consume an order of magnitude less power than incandescent bulbs of equivalent light output. Moreover, with expanding applications and resulting larger volume demand, as well as with new manufacturing techniques, LEDs are increasingly cost effective.

LED-based light strings, used primarily for decorative purposes such as for Christmas lighting, is one application for LEDs. For example, U.S. Pat. No. 5,495,147 entitled LED LIGHT STRING SYSTEM to Lanzisera (hereinafter “Lanzisera”) and U.S. Pat. No. 4,984,999 entitled STRING OF LIGHTS SPECIFICATION to Leake (hereinafter “Leake”) describe different forms of LED-based light strings. In both Lanzisera and Leake, exemplary light strings are described employing purely parallel wiring of discrete LED lamps using a step-down transformer and rectifier power conversion scheme. These and all other LED light string descriptions found in the prior art convert input electrical power, usually assumed to be the common U.S. household power of 110 VAC to a low voltage, nearly DC input.

### SUMMARY OF THE INVENTION

The present invention relates to a light string, including a pair of wires connecting to a standard household AC electrical plug; a plurality of LEDs powered by the pair of wires, wherein the LEDs are electrically coupled in series to form at least one series block; multiple series blocks, if employed, that are electrically coupled in parallel; a standard household AC socket at the opposite end for connection of multiple light strings in an end-to-end, electrically parallel fashion.

It is an object of this invention to provide a method and preferred embodiment that matches the AC voltage rating of the LEDs coupled in series to the AC power input without the need for additional power conversion.

The present invention relaxes the input electrical power conversion and specifies a preferred embodiment in which the LED light string is electrically powered directly from either a common household 110 VAC or 220 VAC source, without a different voltage involved via power conversion. The LEDs may be driven using household AC, rather than DC, because the nominal LED forward bias voltage, if used in reverse bias fashion, is generally much lower than the reverse voltage where the LED p-n junction breaks down. When LEDs are driven by AC, pulsed light is effected at the AC rate (e.g., 60 or 50 Hz), which is sufficiently high in frequency for the human eye to integrate and see as a continuous light stream.

### BRIEF DESCRIPTION OF THE DRAWINGS

Other aspects, features and advantages of the present invention will become more fully apparent from the following detailed description, the appended claims, and the accompanying drawings in which:

FIGS. 1A and 1B show two example block diagrams of the light string in its embodiment preferred primarily, with one diagram for a 110 VAC common household input electrical source (e.g., 60 Hz) and one diagram for a 220 VAC common household (e.g., 50 Hz) input electrical source.

FIGS. 2A and 2B show two example block diagrams of the light string in its embodiment preferred alternatively, with one diagram for a 110 VAC common household input electrical source (e. g., 60 Hz) and one diagram for a 220 VAC common household (e.g., 50 Hz) input electrical source.

FIGS. 3A and 3B show two example schematic diagrams of the AC-to-DC power supply corresponding to the two block diagrams in FIG. 1 for either the 110 VAC or the 220 VAC input electrical source.

FIGS. 5A and 5B show example pictorial diagrams of the manufactured light string in either its “straight” or “curtain” form (either form may be manufactured for 110 VAC or 220 VAC input).

FIGS. 6A-6B show an example pictorial diagram of special tooling of the housing for an LED housing in the light string, for assurance of proper LED electrical polarity throughout the light string circuit.

FIG. 7 shows an example pictorial diagram of special tooling and manufacturing of the LED and housing in the light string, for assurance of proper LED polarity using the example in FIG. 6A.

FIG. 8 shows an example pictorial diagram of a fiber optic “icicle” attached to an LED and housing in the light string, where the “icicle” diffuses the LED light in a predetermined manner.

### DETAILED DESCRIPTION OF PREFERRED EMBODIMENTS

The term “alternating current voltage”, sometimes abbreviated as “VAC”, as used herein occasionally refers to a numerical amount of volts, for example, “220 VAC”. It is to be understood that the stated number of alternating current volts is the nominal voltage which cycles continuously in forward and reverse bias and that the actual instantaneous voltage at a given point in time can differ from the nominal voltage number.

In accordance with the present invention, an LED light string employs a plurality of LEDs wired in series-parallel form, containing at least one series block of multiple LEDs. The series block size is determined by the ratio of the standard input voltage (e.g., either 110 VAC or 220 VAC) to the drive voltage(s) of the LEDs to be employed (e.g., 2 VAC). Further, multiple series blocks, if employed, are each of the same LED configuration (same number and kinds of LEDs), and are wired together along the string in parallel. LEDs of the light string may comprise either a single color LED or an LED including multiple sub-dies each of a different color. The LED lenses may be of any shape, and may be either clear, clear-colored, or diffuse-colored. Moreover, each LED may have internal circuitry to provide for intermittent on-off blinking and/or intermittent LED sub-die color changes. Individual LEDs of the light string may be arranged continuously (using the same color), or periodically (using multiple, alternating CIP colors), or pseudo-randomly (any order of multiple colors). The LED light string may provide an electrical interface to couple multiple lights strings together in parallel, and physically from end to end. Fiber optic bundles or strands may also be coupled to individual LEDs to diffuse LED light output in a predetermined manner.

An LED light string of the present invention may have the following advantages. The LED light string may last far longer and require less power consumption than light strings of incandescent lamps, and they may be safer to operate since less heat is generated. The LED light string may have reduced cost of manufacture by employing series-parallel blocks to allow operation directly from a standard household 110 VAC or 220 VAC source, either without any additional circuitry (AC drive), or with only minimal circuitry (DC drive). In addition, the LED light string may allow multiple strings to be conveniently connected together, using standard 110 VAC or 220 VAC plugs and sockets, desirably from end-to-end.

Direct AC drive of LED light string avoids any power conversion circuitry and additional wires; both of these items add cost to the light string. The additional wires impose additional mechanical constraint and they may also detract aesthetically from the decorative string. However, direct AC drive results in pulsed lighting. Although this pulsed lighting cannot be seen at typical AC drive frequencies (e.g. 50 or 60 Hz), the pulsing apparently may not be the most efficient use of each LED device because less overall light is produced than if the LEDs were continuously driven using DC. This lower amount of light produced may be compensated for by using more expensive, brighter LEDs, and thus an engineering tradeoff exists, where AC drive is of primary reference, and DC drive is preferred alternatively.

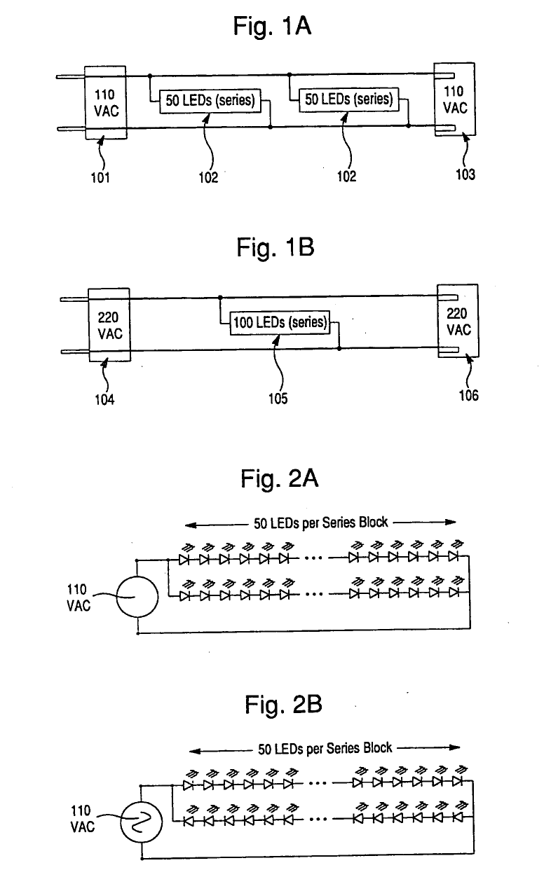

FIG. 1 shows the embodiment of an LED light string in accordance with the present invention, and as preferred primarily through AC drive. In FIG. 1, the two block diagrams correspond to an exemplary string employing 100 LEDs, for either 110 VAC (top diagram) or 220 VAC (bottom diagram) standard household current input (e.g., 50 or 60 Hz). In the top block diagram of FIG. 1, the input electrical interface consists merely of a standard 110 VAC household plug 101 attached to a pair of drive wires. With the average LED drive voltage of each LED assumed to be approximately 2.2 VAC in FIG. 1, the basic series block size for the top block diagram, corresponding to 110 VAC input, is approximately 50 LEDs. Thus, for the 110 VAC version, two series blocks of 50 LEDs 102 are coupled in parallel to the drive wires along the light string. The two drive wires for the 110 VAC light string terminate in a standard 110 VAC household socket 103 to enable multiple strings to be connected in parallel electrically from end-to-end.

In the bottom block diagram of FIG. 1, the input electrical interface likewise consists of a standard 220 VAC household plug 104 attached to a pair of drive wires. With again the average LED drive voltage assumed to be approximately 2.2 VAC in FIG. 1, the basic series block size for the bottom diagram, corresponding to 220 VAC input, is 100 LEDs. Thus, for the 220 VAC version, only one series block of 100 LEDs 105 is coupled to the drive wires along the light string. The two drive wires for the 220 VAC light string terminate in a standard 220 VAC household socket 106 to enable multiple strings to be connected in parallel from end-to-end. Note that for either the 110 VAC or the 220 VAC light string, the standard plug and socket employed in the string varies in accordance to the country in which the light string is intended to be used.

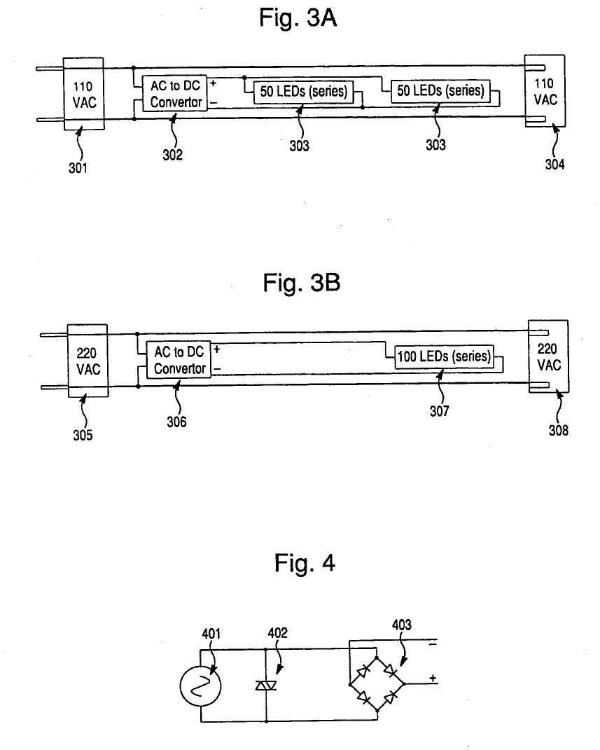

As an alternative preference to AC drive, FIGS. 3A and 3B show two block diagrams that correspond to a exemplary string employing 100 LEDs and DC drive, for either 110 VAC (top diagram) or 220 VAC (bottom diagram) standard household current input (e.g., 50 or 60 Hz). In the top block diagram of FIG. 3A, the input electrical interface consists of a standard 110 VAC household plug 301 attached to a pair of drive wires, followed by an AC-to-DC converter circuit 302. With the average LED drive voltage assumed to be approximately 2.2 VDC in FIG. 3, the basic series block size for the top block diagram, corresponding to 110 VAC input, is approximately 50 LEDs. Thus, for the 110 VAC version, two series blocks of 50 LEDs 303 are coupled in parallel to the output of the AC-to-DC converter 302 using additional feed wires along the light string. The two drive wires for the 110 VAC light string terminate in a standard 110 VAC household socket 304 to enable multiple strings to be connected in parallel electrically from end-to-end.

In the bottom block diagram of FIG. 3B, the input electrical interface likewise consists of a standard 220 VAC household plug 305 attached to a pair of drive wires, followed by an AC-to-DC converter circuit 306. With again the average LED drive voltage assumed to be approximately 2.2 VDC in FIG. 3, the basic series block size for the bottom diagram, corresponding to 220 VAC input, is 100 LEDs. Thus, for the 220 VAC version, only one series block of 100 LEDs 307 is coupled to the output of the AC-to-DC converter 307 using additional feed wires along the light string. The two drive wires for the 220 VAC light string terminate in a standard 220 VAC household socket 308 to enable multiple strings to be connected in parallel from end-to-end. Note that for either the 110 VAC or the 220 VAC light string, the standard plug and socket employed in the string varies in accordance to the country in which the light string is intended to be used.

FIG. 4 shows an example schematic electrical diagram for the AC-to-DC converter employed in both diagrams of FIGS. 3A and 3B. The AC input to the circuit in FIG. 1 is indicated by the symbol for an AC source 401. A varistor 402 or similar fusing device may optionally be used to ensure that voltage is limited during large power surges. The actual AC to DC rectification is performed by use of a full-wave bridge rectifier 403. This bridge rectifier 403 results in a rippled DC current and therefore serves as an example circuit only. A different rectification scheme may be employed, depending on cost considerations. For example, one or more capacitors or inductors may be added to reduce ripple at only minor cost increase. Because of the many possibilities, and because of their insignificance, these and similar additional circuit features have been purposely omitted from FIG. 4.

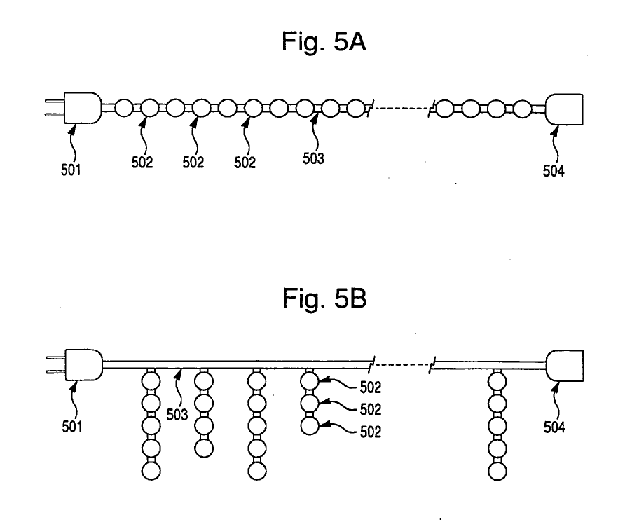

For either the 110 VAC or the 220 VAC version of the LED light string, and whether or not an AC to-DC power converter is used, the final manufacturing may be a variation of either the basic “straight” string form or the basic “curtain” string form, as shown in the top and bottom pictorial diagrams in FIGS. 5A and 5B. In the basic “straight” form of the light string, the standard (110 VAC or 220 VAC) plug 501 is attached to the drive wires which provide power to the LEDs 502 via the series-parallel feeding described previously. The two drive and other feed wires 503 are twisted together along the length of the light string for compactness and the LEDs 502 in the “straight” form are aligned with these twisted wires 503, with the LEDs 502 spaced uniformly along the string length (note drawing is not to scale). The two drive wires in the “straight” form of the light string terminate in the standard (correspondingly, 110 VAC or 220 VAC) socket 504. Typically, the LEDs are spaced uniformly every four inches.

In the basic “curtain” form of the light string, as shown pictorially in the bottom diagram of FIGS. 5A and 5B, the standard (110 VAC or 220 VAC) plug 501 again is attached to the drive wires which provide power to the LEDs 502 via the series-parallel feeding described previously. The two drive and other feed wires 503 are again twisted together along the length of the light string for compactness. However, the feed wires to the LEDs are now twisted and arranged such that the LEDs are offset from the light string axis in small groups (groups of 3 to 5 are shown as an example). The length of these groups of offset LEDs may remain the same along the string or they may vary in either a periodic or pseudo-random fashion. Within each group of offset LEDs, the LEDs 502 may be spaced uniformly as shown or they may be spaced nonuniformly, in either a periodic or pseudo-random fashion (note drawing is not to scale). The two drive wires in the “curtain” form of the light string also terminate in a standard (correspondingly 110 VAC or 220 VAC) socket 504. Typically, the LED offset groups are spaced uniformly every six inches along the string axis and, within each group, the LEDs are spaced uniformly every four inches.

In any above version of the preferred embodiment to the LED light string, blinking may be obtained using a number of techniques requiring additional circuitry, or by simply replacing one of the LEDs in each series block with a blinking LED. Blinking LEDs are already available on the market at comparable prices with their continuous counterparts, and thus the light string may be sold with the necessary (e.g., one or two) additional blinkers included in the few extra LEDs.

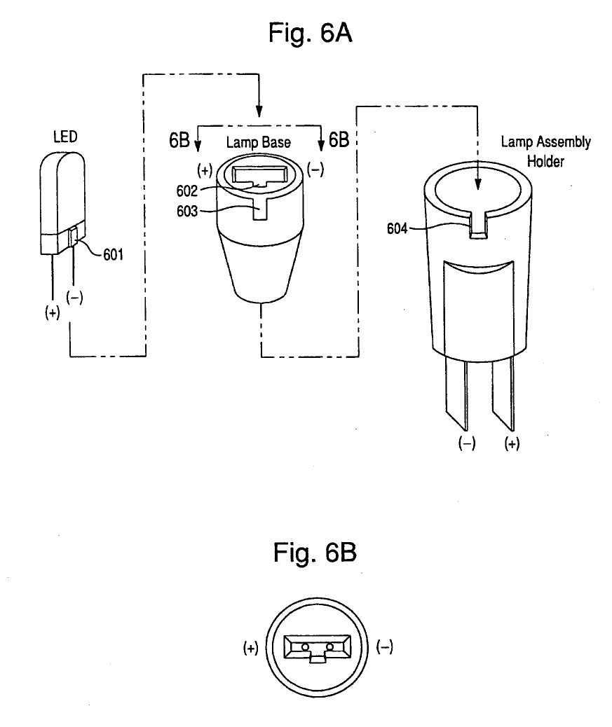

In wiring any version of the preferred embodiment to the light string, as described previously, it is critical that each LED is powered using the correct LED polarity. This equates to all feeds coming from the same drive wire always entering either the positive or the negative lead of each LED. Since the drive wires are AC, it does not matter whether positive or negative is chosen initially; it is only important all the LEDs in each series block have the same polarity orientation (either all positive first or all negative first). In order to facilitate ease of proper manufacturing, as well as ease of proper LED bulb replacement by the user, each LED and its assembly into its housing may be mechanically modified to insure proper polarity. An example of mechanical modification is shown in FIG. 6A, where the LED (shown at far left with a rectangular, arched-top lens) is modified to include a keyed offset 601 on its holder 606, and accordingly, the LED lamp base 605 incorporates a notch 602 to accommodate this keyed offset. This first pair of modifications, useful for manufacturing only, results in the LED being properly mounted within its base to form replaceable LED lamp bulb. In order to properly fit this replaceable LED lamp bulb into its holder on the light string, the lamp base is also modified to include a keyed offset 603 on its base 605, and the lamp assembly holder 607 is correspondingly notched 604 for proper alignment. This second pair of modifications is useful in both manufacturing and by the user, for properly placing or replacing the LED lamp bulb into its holder on the light string. The LED lamp base and holder collectively form the LED housing. Note that such a mechanical arrangement makes it physically impossible to incorrectly insert the LED. FIG. 6B is a top view of the lamp base taken along viewing line 6B-6B of FIG. 6A.

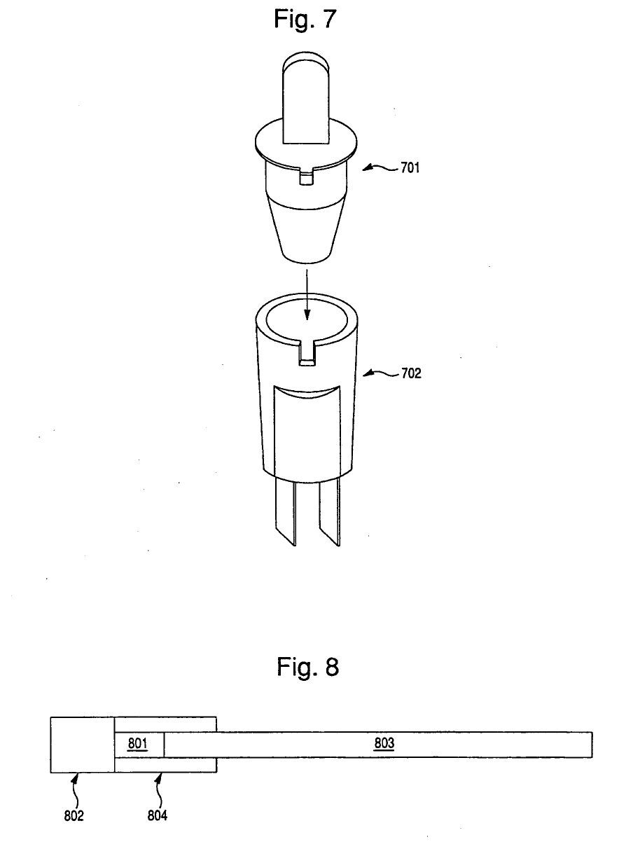

In manufacturing the above modification to assure proper LED polarity, it may be advantageous to build the LED mold such that two piece replaceable LED lamp bulb described in FIG. 6A can be made in one step as a single piece. This is illustrated in FIG. 7, where the single piece replaceable LED lamp bulb 701 has a single keyed offset to fit into its notched lamp holder 702. Although this requires more elaborate modification of the LED base, the resulting assembly is now composed of two, rather than three, LED pieces and as such, may allow the lights string to be made more rapidly and at lower cost.

Typically, the LEDs in the light string will incorporate a lens for wide-angle viewing. However, it is also possible to attach fiber optic bundles or strands to the LEDs to spatially diffuse the LED light in a predetermined way for a desirable visual effect. In such case, the LED lens is designed to create a narrow-angle light beam (e.g., 20 degree beamwidth or less) along its axis, to enable the LED light to flow through the fiber optics with high coupling efficiency. An example of the use of fiber optics is shown in FIG. 8, where a very lossy fiber optic rod is employed with intention for the fiber optic rod to glow like an illuminated “icicle.” In FIG. 8, the LED 801 and its housing 802 may be attached to the fiber optic rod 803 using a short piece of tubing 804 that fits over both the LED lens and the end of the fiber optic rod (note that the drawing is not to scale). An example design uses a cylindrical LED lens with a narrow-angle end beam, where the diameter of the LED lens and the diameter of the fiber optic rod are the same (e.g., 5 mm or 3/16 inches). The fiber optic rod 803 is typically between three to eight inches in length and may be either uniform in length throughout the light string, or the fiber optic rod length may vary in either a periodic or pseudo-random fashion.

Although the fiber optic rod 803 in FIG. 8 could be constructed using a variety of plastic or glass materials, it may be preferred that the rod is made in either a rigid form using clear Acrylic plastic or clear crystal styrene plastic, or in a highly flexible form using highly plasticized Polyvinyl Chloride (PVC). These plastics are preferred for safety, durability, light transmittance, and cost reasons. It may be desirable to add into the plastic rod material either air bubbles or other constituents, such as tiny metallic reflectors, to achieve the designed measure of lossiness for off-axis glowing (loss) versus on-axis light conductance. Moreover, it is likely to be desirable to add UV inhibiting chemicals for longer outdoor life, such as a combination of hindered amine light stabilizer (HALS) chemicals. The tubing 804 that connects the fiber optic rod 803 to its LED lens 801 may also made from a variety of materials, and be specified in a variety of ways according to opacity, inner diameter, wall thickness, and flexibility. From safety, durability, light transmittance, and cost reasons, it may be preferred that the connection tubing 804 be a short piece (e.g., 10 mm in length) of standard clear flexible PVC tubing (containing UV inhibiting chemicals) whose diameter is such that the tubing fits snugly over both the LED lens and the fiber optic rod (e.g., standard wall tubing with ¼ inch outer diameter). An adhesive may be used to hold this assembly more securely.

It will be understood that various changes in the details, materials and arrangements of the parts which have been described and illustrated in order to explain the nature of this invention may be made by those skilled in the art without departing from the principle and scope of the invention as expressed in the following claims.

1. A stable light string providing illumination over an extending period of time in excess of several hours, said light string comprising:
a predetermined number of light emitting diodes electrically coupled in series to form at least one series block, each light emitting diode having a lamp base and internal circuitry defining an average alternating current drive voltage, the series block having a first diode and a last diode, the first diode directly coupled intermediate a source end and a terminal end of a first of a pair of wires and the last diode directly coupled intermediate the source end and terminal end of a second of the pair of wires,
the light string being free from additional circuitry intermediate the first diode and the source end of the first pair of wires, between each of the diodes, and intermediate the last diode and the source end of the second pair of wires, and
a first connector coupled to both the source end of the first of the pair of wires and the source end of the second of the pair of wires which connector facilitates a direct connection between the first diode and a first side of an alternating current electrical power supply, and the last diode and a second side of the alternating current electrical power supply, the supply having a supply voltage, the predetermined number of diodes substantially calculated by dividing the supply voltage by the average alternating current drive voltage,
wherein said direct connection is void of any additional current limiting circuitry in addition to said pair of wires.

2. The light string of claim 1 in which the light string is adapted to accept alternating current electricity without an intervening conversion to direct current electricity.

3. The light string of claim 2 further comprising a second pair of wires supporting the LEDs.

4. The light string of claim 1 in which the electrical power supply provides alternating current having an alternating current voltage of at least about 110 volts.

5. The light string of claim 4 in which each LED has a p-n junction defining a break down voltage above which voltage applied in reverse bias said p-n junction breaks down, and in which light string the alternating current voltage is less than the break down voltage.

6. The light string of claim 5 in which the alternating current voltage is in the range of about 110-220 volts.

7. The light string of claim 1 in which the alternating current has a frequency effective to cause each LED to emit pulsed light which the human eye perceives as continuous.

8. The light string of claim 7 in which the frequency is at least about 50 Hz.

9. The light string of claim 1 in which the first connector is polarized, and which light string further comprises a second polarized connector electrically connected to the terminal end of the first of the pair of wires and the terminal end of the second of the pair of wires, said second polarized connector being adapted to couple with a first polarized connector of another light string, thereby providing for coupling of multiple light strings in an end-to-end arrangement.

10. The light string of claim 1 in which the number of LEDs of each series block is at most a maximum number determined by the electrical power supply.

11. The light string of claim 1 in which each LED has a corresponding light output color and all of the LEDs in each series block is of the same color.

12. The light string of claim 1 in which each LED has a corresponding light output color and all of the LEDs in each series block is of different colors.

13. The light string of claim 11 in which at least one LED comprises a housing and a fiber-optic bundle removably mounted to the housing operative to diffuse light output of the LED through the fiber-optic bundle.

14. The light string of claim 1 in which the LEDs are offset from the wires and arranged relative to a wire axis.

15. The light string of claim 14 in which each LED is arranged parallel to the wires to create a straight arrangement.

16. The light string of claim 15 in which the LEDs in each series block are uniformly spaced apart.

17. The light string of claim 14 in which the LEDs are arranged in offset groupings, each offset grouping having a length relative to the LEDs therein, and are arranged perpendicular to the wires to create a light string having a curtain arrangement.

18. The light string of claim 17, wherein the LEDs are uniformly spaced by a first distance within an offset grouping and each offset grouping is uniformly spaced by a second distance along the drive wire axis.

19. The light string of claim 1, further comprising a lamp holder having a keyed offset, the lamp holder fixedly attached to each LED through said lamp base having a notch adapted to receive the keyed offset of the lamp holder, thereby mechanically orienting and aligning each LED by its polarity.

20. The light string of claim 19, wherein the lamp base further comprises a base keyed offset and a lamp assembly holder, the lamp assembly holder having a notch adapted to receive the base keyed offset.
